(19) United States
(12) Patent Application Publication
(10) Pub. No.: US 2026/0203697 A1
(43) Pub. Date: Jul. 16, 2026

(54) INFORMATION PROCESSING APPARATUS, TRAINED MODEL, INFORMATION PROCESSING METHOD, AND PROGRAM

(71) Applicant: NEC Corporation, Tokyo (JP)

(72) Inventors: Takeshi AKAGAWA, Tokyo (JP); Satoshi ODA, Tokyo (JP); Hideki KOMORI, Tokyo (JP)

(73) Assignee: NEC Corporation, Tokyo (JP)

(21) Appl. No.: 19/138,180

(22) PCT Filed: Nov. 24, 2023
(86) PCT No.: PCT/JP2023/042154

§ 371 Date: Jun. 12, 2025

(30) Foreign Application Priority Data
Dec. 22, 2022 (JP) 2022-205626

(51) Int. Cl. G06Q 10/0639; G06N 20/00

(52) U.S. Cl. CPC G06Q 10/06393; G06N 20/00

(57) ABSTRACT

An object is to provide an information processing apparatus capable of appropriately evaluating work performance ability. The information processing apparatus according to the present disclosure includes: an attribute information reception unit configured to receive attribute information of an individual; a value estimation unit configured to estimate, based on the attribute information of the individual, a value of a work performance ability included in the attribute information by using a trained model; and a value output unit configured to output estimated value information indicating the estimated value. The trained model is trained by using demand information on a demand for the work performance ability, supply information on a supply of the work performance ability, relevant information that may affect at least one of the demand and the supply, and value information indicating a value of the work performance ability as teacher data.

### TECHNICAL FIELD

The present disclosure relates to an information processing apparatus, a trained model, an information processing method, and a program.

### BACKGROUND ART

In the labor market, the market value of a worker's work performance ability (e.g., skills and knowledge) changes along with the current trends. Therefore, it is desirable to appropriately evaluate the market value of the work performance ability of each individual worker in line with these current trends.

As related art, Patent Literature 1 discloses a social simulation system for predicting or calculating social or market dynamics. After employer agents and worker agents match with each other in the simulated world, the system confirms evaluations made by both parties towards each other. If the level of evaluations of each other is high, the system presents information to the employer and the worker and takes measures to introduce them to each other in the real world.

### CITATION LIST

### Patent Literature

[Patent Literature 1] Japanese Unexamined Patent Application Publication No. 2006-146858

### SUMMARY OF INVENTION

### Technical Problem

Workers can increase their market values by improving their work performance ability. In addition, by making workers aware of the market values of their work performance ability, they can increase their motivation to improve their work performance ability. However, it is difficult to quantitatively evaluate the market value of a worker's work performance ability.

An object of the present disclosure is to provide an information processing apparatus, a trained model, an information processing method, and a program capable of appropriately evaluating work performance ability in view of the above-mentioned problems.

### Solution to Problem

An information processing apparatus according to the present disclosure includes: an attribute information reception unit configured to receive attribute information of an individual; a value estimation unit configured to estimate, based on the attribute information of the individual received by the attribute information reception unit, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and a value output unit configured to output estimated value information indicating the value estimated by the value estimation unit.

A trained model according to the present disclosure includes: an input layer configured to receive input of demand information on a demand for the work performance ability, supply information on a supply of the work performance ability, and relevant information that may affect at least one of the demand and the supply; and an output layer configured to estimate a value of the work performance ability corresponding to the demand information, the supply information, and the relevant information and output the estimated value, in which the trained model causes a computer to function to input a work performance ability included in attribute information of an individual into the input layer and output an estimated value from the output layer.

An information processing method according to the present disclosure includes: an attribute information reception step of receiving attribute information of an individual; a value estimation step of estimating, based on the attribute information of the individual received in the attribute information reception step, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and a value output step of outputting estimated value information indicating the value estimated in the value estimation step.

A program according to the present disclosure causes a computer to execute: an attribute information reception step of receiving attribute information of an individual; a value estimation step of estimating, based on the attribute information of the individual received in the attribute information reception step, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and a value output step of outputting estimated value information indicating the value estimated in the value estimation step.

### Advantageous Effects of Invention

An information processing apparatus, a trained model, an information processing method, and a program according to the present disclosure are capable of appropriately evaluating work performance ability.

### BRIEF DESCRIPTION OF DRAWINGS

FIG. 1 is a block diagram showing a configuration of an information processing apparatus according to the present disclosure;

FIG. 2 is a flowchart showing processing performed by the information processing apparatus according to the present disclosure;

FIG. 3 is a block diagram showing a configuration of an information processing system according to the present disclosure;

FIG. 4 is a block diagram showing a configuration of an information processing apparatus according to the present disclosure;

FIG. 5 is a diagram showing an example of teacher data according to the present disclosure;

FIG. 6 is a diagram showing an example of a trained model according to the present disclosure;

FIG. 7 is a diagram showing a specific example of weighting according to the present disclosure;

FIG. 8 is a flowchart showing processing performed by the information processing apparatus according to the present disclosure;

FIG. 9 is a diagram showing an example of display information for displaying estimated value information according to the present disclosure; and

FIG. 10 is a block diagram illustrating a hardware configuration of a computer implementing an information processing apparatus according to the present disclosure.

### EXAMPLE EMBODIMENT

Example embodiments of the present disclosure will be described in detail below with reference to the drawings. In each drawing, the same or corresponding elements have the same reference numerals. Repeated descriptions are omitted as necessary for clarity.

### First Example Embodiment

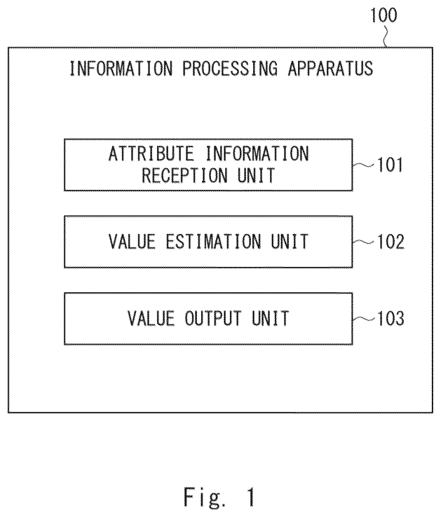

First, with reference to FIG. 1, a configuration of an information processing apparatus 100 according to the present disclosure will be described. FIG. 1 is a block diagram showing a configuration of the information processing apparatus 100. The information processing apparatus 100 includes an attribute information reception unit 101, a value estimation unit 102, and a value output unit 103.

The attribute information reception unit 101 receives attribute information of an individual. The value estimation unit 102 estimates, based on the attribute information of the individual received by the attribute information reception unit 101, a value of a work performance ability included in the attribute information by using a trained model.

The trained model is trained by using demand information on demand for the work performance ability, supply information on supply of the work performance ability, relevant information that can affect at least one of the demand and supply, and value information indicating a value of the work performance ability as teacher data.

The value output unit 103 outputs estimated value information indicating the value estimated by the value estimation unit 102.

The information processing apparatus 100 includes a processor, a memory, and a storage device as components not shown. The storage device stores a computer program in which processing according to the present disclosure is implemented. The processor can load the computer program from the storage device into the memory and execute this computer program. In this way, the processor implements the functions of the attribute information reception unit 101, the value estimation unit 102, and the value output unit 103.

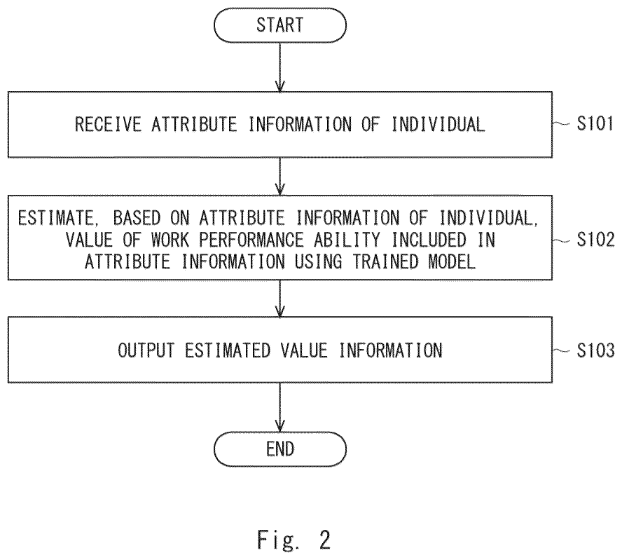

Next, with reference to FIG. 2, processing performed by the information processing apparatus 100 will be described. FIG. 2 is a flowchart showing processing performed by the information processing apparatus 100.

First, the attribute information reception unit 101 receives attribute information of an individual (S101). Next, the value estimation unit 102 estimates, based on the received attribute information of the individual, a value of a work performance ability included in the attribute information using a trained model (S102). Next, the value output unit 103 outputs estimated value information indicating the estimated value (S103).

With this configuration, according to the information processing apparatus 100 of this example embodiment, it is possible to appropriately evaluate the work performance ability.

### Second Example Embodiment

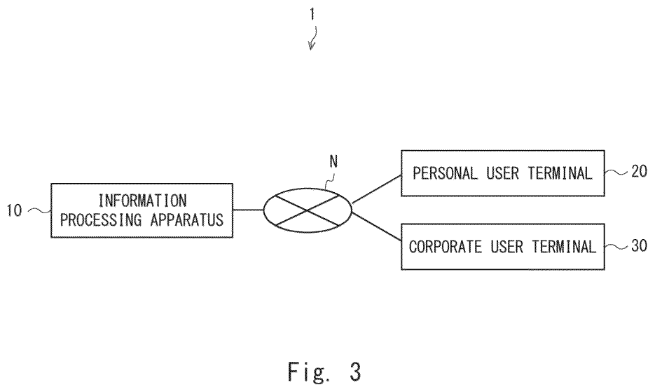

Next, with reference to FIGS. 3 to 10, a second example embodiment will be described. The second example embodiment is a specific example of the first example embodiment described above.

### (Configuration of Information Processing System 1)

First, with reference to FIG. 3, a configuration of an information processing system 1 according to the present disclosure will be described. FIG. 3 is a block diagram showing the configuration of the information processing system 1. As shown in the drawing, the information processing system 1 includes an information processing apparatus 10, a personal user terminal 20, and a corporate user terminal 30. The information processing system 1 may include a plurality of the personal user terminals 20 and a plurality of the corporate user terminals 30.

Each of the information processing apparatus 10, the personal user terminal 20, and the corporate user terminal 30 is connected to each other via a network N. The network N is a wired or wireless communication line. The network N may be, for example, the Internet, dedicated lines, telephone line, mobile communication network, or other communication lines. The network N may also be a combination of them.

The information processing apparatus 10 is an example of the information processing apparatus 100 described above. The information processing apparatus 10 is an information processing apparatus capable of estimating a value of a work performance ability of an individual by performing predetermined information processing and then outputting the estimated value.

The work performance ability indicates an ability to perform work. The work performance ability may include skills, such as technical or practical abilities, required to perform specific work. An example of the skills is ability to work in translation, programming, management, clerical, accounting, sales, or marketing. These are just examples, and other various skills can be part of the work performance ability.

The work performance ability may also include knowledge related to work, information, education, qualifications, available tools, or proficiency in these tools. The work performance ability can also be associated with industries or professions. The work performance ability of an individual may include a plurality of skills and knowledge areas.

The personal user terminal 20 is a terminal used by a personal user. The corporate user terminal 30 is a terminal used by a corporate user.

Here, the personal user indicates a person who has the work performance ability whose value is to be estimated. The personal user can estimate the value of his/her work performance ability by using the personal user terminal 20 and acquire the value that has been estimated (hereinafter may be referred to as estimated value). Thus, the personal user can grasp the estimated value of his/her work performance ability, for example, for job placement or job change.

In addition, the corporate user indicates a person or the like who uses the information processing system 1 as a job offeror who provides a job offer to the personal user. The corporate user acquires the estimated value of the work performance ability possessed by the personal user by using the corporate user terminal 30. Thus, the corporate user can utilize the acquired estimated value for recruitment activities, for example.

The personal user terminal 20 and the corporate user terminal 30 may each be, for example, a personal computer (PC), a tablet terminal, or a smartphone. The personal user terminal 20 and the corporate user terminal 30 transmit and receive data to and from the information processing apparatus 10 via the network N.

The personal user terminal 20 and the corporate user terminal 30 are each provided with an input unit (not shown) and receive input of information from each user. The input unit of each of the personal user terminal 20 and the corporate user terminal 30 is, for example, an input device such as a keyboard.

The personal user terminal 20 and the corporate user terminal 30 are each provided with an output unit (not shown), and output information to each user. The output unit of each of the personal user terminal 20 and the corporate user terminal 30 is, for example, a display device such as a display.

The personal user terminal 20 and the corporate user terminal 30 may each be configured to include an input/output unit having functions of an input unit and an output unit. The input/output unit is, for example, a display with a touch panel that allows input operations to be performed by touching with a finger or similar means.

### (Outline of Processing Performed by Information Processing System 1)

An outline of processing performed by the information processing system 1 will now be described. The input unit of the personal user terminal 20 receives input of the attribute information from the personal user. Here, the attribute information is information indicating an attribute of the personal user. The attribute information includes information on the work performance ability of the personal user. Therefore, the attribute information may include, for example, information on the skills, knowledge, industry, or profession of the personal user, which are aspects of the work performance ability.

The attribute information may also include information other than the work performance ability. The attribute information may include, for example, the number of job changes, educational background, previous salary, or desired working conditions (e.g., working hours, employment contracts, or work location).

The personal user registers the contents including the attribute information in the information processing apparatus 10 using the personal user terminal 20. The personal user may input the attribute information using, for example, an input form screen for registering a resume. In this manner, the information processing apparatus 10 receives the attribute information of the personal user from the personal user terminal 20.

The information processing apparatus 10 estimates the value of the work performance ability included in the received attribute information by performing predetermined processing using the trained model. The trained model can be stored in the information processing apparatus 10.

The trained model is previously trained using the demand information, the supply information, the relevant information, and the value information as teacher data. The demand information is information on demand for the work performance ability. The demand information can be obtained based on a plurality of job postings. The supply information is information on supply of the work performance ability. The supply information can be obtained based on attribute information of a plurality of individuals.

The relevant information is information that can affect at least one of the supply and demand. The relevant information can include, for example, information on tools to replace work performance ability and information on world affairs. The relevant information can be obtained from, for example, information posted on social networking services (SNS) or information on news sites.

The value information is information indicating the value of the work performance ability. The value information is related to the demand information, the supply information, and the relevant information. For example, a value of a work performance ability A may vary depending on the balance of supply and demand for work performance ability A and the availability of tools to replace the work performance ability A. The value information may be acquired based on attribute information of a plurality of individuals or the like.

The information processing apparatus 10 outputs estimated value information indicating the value estimated by using the trained model. The estimated value information may be expressed, for example, as a score (numerical value) or a consideration (monetary value) indicating the estimated value of the work performance ability. The estimated value information may be expressed by an estimated annual income or the like. The estimated value information may also be expressed by a score or the like indicating the balance between supply and demand for work performance ability.

The information processing apparatus 10 causes, for example, the personal user terminal 20 to output the estimated value information. As a result, the personal user can recognize the estimated value corresponding to his/her work performance ability. The information processing apparatus 10 may cause the corporate user terminal 30 to output the estimated value information. Thus, the corporate user can grasp the estimated value corresponding to the work performance ability possessed by the personal user.

### (Configuration of Information Processing Apparatus 10)

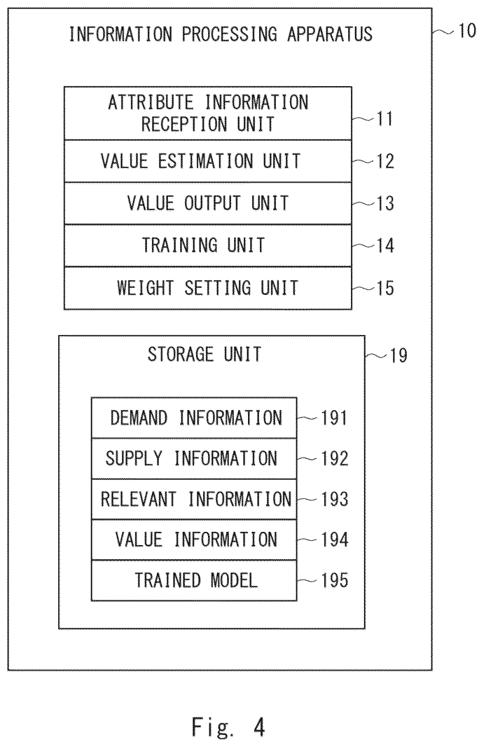

Next, with reference to FIG. 4, a configuration of the information processing apparatus 10 will be described. FIG. 4 is a block diagram showing the configuration of the information processing apparatus 10. The information processing apparatus 10 includes an attribute information reception unit 11, a value estimation unit 12, a value output unit 13, a training unit 14, a weight setting unit 15, and a storage unit 19.

The attribute information reception unit 11 is an example of the attribute information reception unit 101 described above. The attribute information reception unit 11 receives attribute information of a personal user. The attribute information reception unit 11 causes the personal user terminal 20 to display an input form screen or the like for registering a resume, for example, to receive input to the input form.

The attribute information includes information on the work performance ability. The information on the work performance ability may include, for example, information on the skills, knowledge, industry, profession, qualifications, tools he/she can use, or proficiency with such tools of the personal user. The attribute information may also include information other than the work performance ability. The information other than the work performance ability may include, for example, the number of job changes, educational background, previous salary, or desired working conditions.

The value estimation unit 12 is an example of the value estimation unit 102 described above. The value estimation unit 12 estimates the value of the work performance ability included in the attribute information using the trained model based on the attribute information of the individual received by the attribute information reception unit 11.

If the work performance ability includes a plurality of skills, the value estimation unit 12 may estimate the value for the whole work performance ability or for each of the plurality of skills. The value estimation unit 12 can express the estimated value by using, for example, a score or a consideration. In addition, the value estimation unit 12 can estimate the balance between supply and demand for the work performance ability and express the balance by a score or the like.

For example, suppose that a personal user has a work performance ability A including skills a1, a2, and a3. In this case, the value estimation unit 12 can estimate a value corresponding to each of the skills a1 to a3, and express the estimated value by using the score or consideration corresponding to each skill. In this way, the value estimation unit 12 can estimate the value for each skill possessed by the personal user. The value estimation unit 12 may divide, for example, the skills a1 to a3 into groups and estimate the value for each group.

The value estimation unit 12 may estimate the value corresponding to the entire work performance ability A (skills a1 to a3) and express the estimated value by using the score or the consideration corresponding to the work performance ability A. In this case, the value estimation unit 12 may express the annual income of the personal user having the work performance ability A as the estimated value.

The value estimation unit 12 estimates the value of the work performance ability using a trained model 195 previously stored in the storage unit 19. The trained model 195 is previously trained using demand information 191, supply information 192, relevant information 193, and value information 194 stored in the storage unit 19 as teacher data. The trained model 195 will be described in detail later.

The value output unit 13 is an example of the value output unit 103 described above. The value output unit 13 outputs estimated value information indicating the value estimated by the value estimation unit 12. The value output unit 13 may cause the personal user terminal 20 or the corporate user terminal 30 to output the estimated value information or cause an output unit (not shown) provided in the information processing apparatus 10 to output the estimated value information. The estimated value information may be display information for displaying the estimated value using, for example, characters or images.

The training unit 14 trains the trained model 195. The training unit 14 generates the trained model 195 by performing training using the demand information 191, the supply information 192, the relevant information 193, and the value information 194 as teacher data.

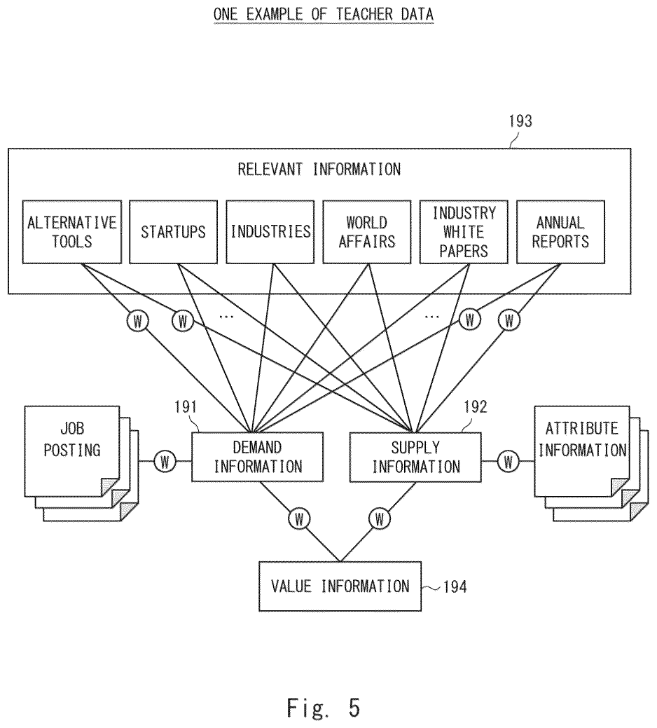

With reference to FIG. 5, the teacher data used for training will now be described. FIG. 5 is a diagram showing an example of the teacher data.

As shown by solid lines in the diagram, the demand information 191, the supply information 192, the relevant information 193, and the value information 194 are related to each other. For example, the demand information 191 and the supply information 192 can affect the value information 194. The relevant information 193 can also affect at least one of the demand information 191 and the supply information 192. Note that the solid lines shown in the drawing show an example of the relationship between the plurality of pieces of information and do not exclude relationships other than those shown. For example, the relevant information 193 and the value information 194 may be related to each other.

Further, W shown in the drawing indicates a weight associated between the plurality of pieces of information. The weight W can be set automatically or manually in the weight setting unit 15 described later. The training unit 14 trains the trained model 195 using the set weight W.

As an example of the relevant information 193, the drawing shows information on alternative tools (alternative means), startups, industries, world affairs, industry white papers, and annual reports. Since these are examples, other information may be used as the relevant information 193.

The training unit 14 acquires information serving as teacher data via the network N or the like. For example, the training unit 14 acquires the demand information 191 on the basis of a plurality of job postings acquired from a plurality of corporate user terminals 30, a job posting site, and the like. The training unit 14 further acquires the supply information 192 on the basis of attribute information of a plurality of individuals registered via a plurality of personal user terminals 20 and the like.

The training unit 14 acquires information on each of alternative tools, startups, industries, world affairs, industry white papers, or annual reports as the relevant information 193 via the network N or the like.

The alternative tools indicate the existence of alternative means of a work performance ability. The alternative tools include, for example, applications using artificial intelligence (AI). The startups indicate information on the startup and its technology.

The training unit 14 acquires character information posted on SNS, for example, and acquires information on alternative tools and startups as the relevant information 193 based on the character information. Specifically, the training unit 14 performs natural language processing on character information acquired from SNS or the like. Thus, the training unit 14 extracts the meaning contained in the character information. The meaning contained in the character information may include information of evaluation for, for example, an alternative tool.

Based on the acquired information, the training unit 14 trains the trained model 195 so that the value of the work performance ability becomes smaller as at least one of the quality and quantity of the alternative tool increases. For example, suppose that the alternative tool is a translation tool. The training unit 14 extracts favorable posts for the translation tool such as “the accuracy of the translation tool T1 has been improved” or “the translation tool T2 is easy to use” on SNS or the like.

Based on the extracted posts, the training unit 14 determines whether at least one of the quality and quantity of the translation tool has increased. If the training unit 14 determines that either one has increased, the training unit 14 trains the trained model 195 so that the value of the translation skill possessed by the individual becomes small. The training unit 14 may extract the product name or the like of the translation tool and determine the change in the quantity of the translation tool. In addition, the training unit 14 may train the trained model 195 so that the value of the work performance ability increases as at least one of the quality and quantity of the alternative tool decreases.

In this way, the training unit 14 can extract the meaning contained in the post about the alternative tool and use the extracted result to train the trained model 195. As a result, the training unit 14 can train the trained model 195 so that the value of the skill decreases as the human work is more replaced by AI.

It is also assumed that the market will expand due to the increase in the number of alternative tools and the demand for the work performance ability will increase. Taking into account the relation with other information, the training unit 14 may change the value of the alternative tool appropriately in accordance with the market trends to train the trained model 195. The training unit 14 may extract the meaning of the information by performing natural language processing on image information, not limited to character information.

The training unit 14 similarly extracts the meaning contained in the information on startups as well, and trains the trained model 195 by using the information affecting the value of the work performance ability.

The training unit 14 may acquire the relevant information 193 from other media, not only from SNS or the like. For example, the training unit 14 acquires information on trends in the industry to which the corporate user (job offeror) belongs as the relevant information 193. The information on trends in the industry is, for example, information contained in publications issued by the corporate user or the industry to which the corporate user belongs. The training unit 14 extracts, from the publications, information that can affect at least one of the supply and demand of the work performance ability. A publication is a document such as an annual report issued by a corporate user or an industry white paper issued in the industry to which the corporate user belongs.

With reference once again to FIG. 5, the value information 194 will be described. The value information 194 is information indicating the value of the work performance ability. The training unit 14 obtains the value corresponding to the demand information 191, the supply information 192, and the relevant information 193, and stores it in the storage unit 19 as the value information 194.

The value information 194 can be expressed, for example, by a score or a consideration indicating the value of the work performance ability. The value information 194 may be expressed by an annual income or the like.

The training unit 14 stores the demand information 191, the supply information 192, the relevant information 193, and the value information 194 acquired at a predetermined timing in association with each other in the storage unit 19. For example, the training unit 14 stores a work performance ability of a personal user at a predetermined timing and the value (for example, an annual income of the personal user) corresponding to the work performance ability in association with the demand information 191, the supply information 192, and the relevant information 193 at the predetermined timing as the value information 194. The training unit 14 may acquire, for example, the annual income corresponding to the work performance ability by extracting information such as the basic salary from the job posting.

The training unit 14 acquires the demand information 191, the supply information 192, the relevant information 193, and the value information 194 as described above, and accumulates them as teacher data. The training unit 14 can generate a trained model 195 for estimating the value corresponding to an unknown work performance ability by performing training using the teacher data.

The training unit 14 may estimate the future market value based on the demand information 191, the supply information 192, and the relevant information 193 at a plurality of different times, and use the estimated market value to train the trained model 195. Here, the future indicates a timing at which a predetermined period has elapsed from the present. The training unit 14 can set the predetermined period in advance. Thus, the trained model 195 can perform training based on the estimated future market value.

For example, the training unit 14 stores the demand information 191, the supply information 192, and the relevant information 193 in association with the acquisition date and time, the update date and time and the like of the respective pieces of information. Thus, the training unit 14 can use the respective pieces of information at a plurality of different times for training.

For example, the training unit 14 compares the past job posting with the current job posting. The training unit 14 determines the transition of the value of the work performance ability based on the comparison result. The training unit 14 estimates the future market value after a predetermined period has passed based on the transition of the value. The training unit 14 trains the trained model 195 so that the trained model 195 performs training using the estimated market value. In this way, the trained model 195 can output the estimation result based on the information acquired at different times, taking into account the decrease in the value of the work performance ability with the passage of time and changes in the world affairs.

The training unit 14 may train the trained model 195 by setting the expiration date of the work performance ability. The expiration date of the work performance ability indicates the time when the value of the current work performance ability is assumed to fall below a predetermined value.

Specifically, the value of the work performance ability can be estimated using multiple regression analysis. In multiple regression analysis, if the value to be estimated is denoted by a target variable Y, the target variable Y can be expressed by the following formula using explanatory variables X1, X2, X3, and partial regression coefficients b1, b2, b3,

$$\begin{matrix}[ Expression 1 ] & \\ Y = b 1 X 1 + b 2 X 2 + b 3 X 3 + … + b 0 & ( 1 )\end{matrix}$$

Here, the target variable Y is the estimated value of the work performance ability of the personal user. X1, X2, X3, . . . are information indicated by the demand information 191, the supply information 192, and the relevant information 193 shown in FIG. 5, respectively. The partial regression coefficients b1, b2, b3, . . . correspond to the weights W described above. Note that b0 indicates a bias.

The target variable Y may be, for example, a score or a consideration of a work performance ability. If the work performance ability includes a plurality of skills, the target variable Y may be the value of some of the skills or the value of the overall work performance ability. For example, the target variable Y may be the consideration (for example, annual income) of the overall work performance ability. The target variable Y may be an amount of demand indicating the size of the demand or an amount of supply indicating the size of the supply.

Furthermore, the target variable Y may be information indicating the balance between demand and supply.

The explanatory variables X1, X2, X3, . . . are, for example, scores based on information on each of the job posting, attribute information, alternative tools, startups, industries, world affairs, industry white papers, and annual reports shown in FIG. 5. That is, the score based on the job posting can be X1, the score based on the attribute information can be X2, and the score based on the alternative tools can be X3,

For example, suppose that an estimated value of a translation skill is to be determined. The score X1 based on the job posting is obtained from the entire job posting of the company. For example, the training unit 14 sets X1=10 in a case where there is a large demand for the translation skill, and sets X1=5 in a case where there is a small demand. The training unit 14 may determine whether there is a large or small demand by using a predetermined threshold. The threshold may be appropriately changed. The same applies to other explanatory variables.

The score X2 based on the attribute information is obtained from the entire attribute information of the job seeker. For example, the training unit 14 sets X2=−10 in a case where the supply of translation skills is large, and sets X2=−5 in a case where the supply is small. X1 and X2 may be set based on a recruitment period and a recruitment rate of skills. For example, the training unit 14 sets X1 and X2 so that the longer the recruitment period, the greater the demand than the supply. The training unit 14 sets X1 and X2 so that the greater the adoption rate, the greater the demand than the supply.

The score X3 based on the information on the alternative tool is obtained based on the information extracted using natural language analysis from, for example, SNS. For example, the training unit 14 sets X3=−20 in a case where posts about the alternative tool are favorable or the number of posts is large. The training unit 14 sets X3=0 in a case where posts about the alternative tool are unfavorable or the number of posts is small. The training unit 14 may set X3 based on the scarcity (e.g., price or prevalence) of the alternative tool or the replacement rate.

The training unit 14 may similarly set scores X4 through X8 based on information on startups, industries, world affairs, industry white papers, and annual reports. The training unit 14 adjusts the coefficients b1 through b8 multiplied by X1 through X8 to train the trained model 195 so that the trained model 195 outputs an appropriate estimation result.

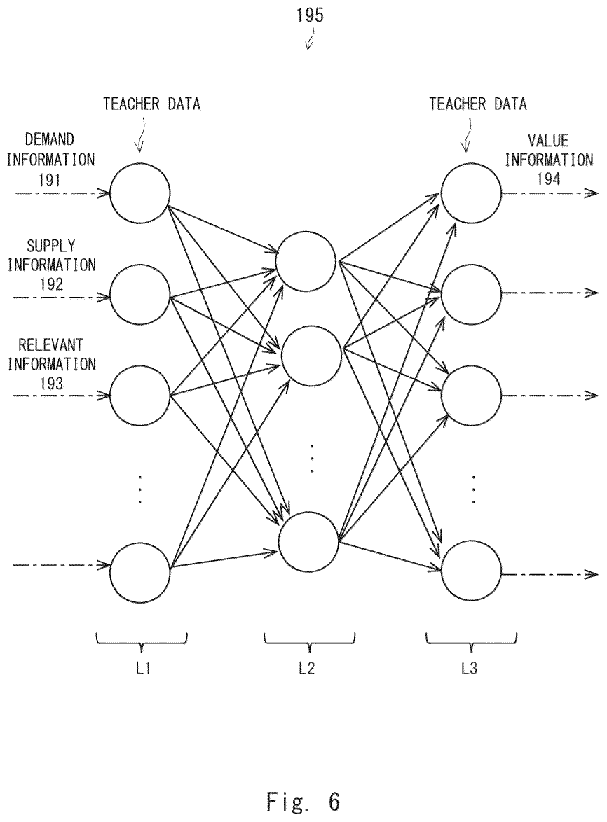

With reference to FIG. 6, the trained model 195 will now be described. FIG. 6 is a diagram showing an example of the trained model 195. The trained model 195 is, for example, a neural network in which the demand information 191, the supply information 192, and the relevant information 193 are input and the value information 194 is output. The neural network may be, for example, a Convolution Neural Network (CNN).

As shown in the drawing, the trained model 195 has a multilayer structure including, for example, an input layer L1, an intermediate layer L2, and an output layer L3. In the drawing, neuronal elements of each layer are shown by circles, and transmission elements connecting each layer are shown by solid arrows. The transmission elements have weighted values to transmit the state of the neuronal elements from the input layer L1 to the output layer L3. Information input to the input layer L1 and information output from the output layer L3 are shown by dash-dot lines.

As shown in the drawing, the input layer L1 has neuronal elements that receive input of the demand information 191, the supply information 192, and the relevant information 193. The intermediate layer L2 also has neuronal elements into which output from the input layer L1 is input, and each one of the neuronal elements is coupled to each one of the neuronal elements of the input layer L1 via transmission elements.

Based on the demand information 191, the supply information 192, the relevant information 193, and the value information 194, which are teacher data, the intermediate layer L2 performs machine learning on parameters used for arithmetic processing for extracting, from the demand information 191, the supply information 192, and the relevant information 193, feature values of these information pieces. A well-known algorithm may be used for machine learning.

The output layer L3 has neuronal elements into which the output from the intermediate layer L2 is input, and each one of the neuronal elements is coupled to each one of the neuronal elements of the intermediate layer L2 via transmission elements. The output layer L3 estimates the value of the work performance ability included in the attribute information input to the input layer L1 based on the calculation result in the intermediate layer L2, and outputs the value information.

After an unknown work performance ability is input to the trained model 195, the trained model 195 outputs a value estimated from the unknown work performance ability. The trained model 195 performs training using a difference between the value information 194 and the estimated value as an error in such a way that this error is reduced. The trained model 195 is constructed in such a way that this error is minimized, for example.

In this way, the trained model 195 can cause the computer to function to input the work performance ability included in the attribute information of the individual into the input layer and output the estimated value from the output layer. Since the example shown in FIG. 6 is an example, the configuration of the trained model 195 is not limited to that shown. For example, the intermediate layer L2 may be configured with a multilayer structure. The trained model 195 may also be constructed using a method other than a neural network.

Referring once again to FIG. 4, a further explanation will be given. The weight setting unit 15 sets a weight for at least one of the demand information, the supply information, and the relevant information. The weight setting unit 15 can automatically perform weighting using well-known techniques. For example, the weight setting unit 15 determines the weight based on a combination of industry with profession.

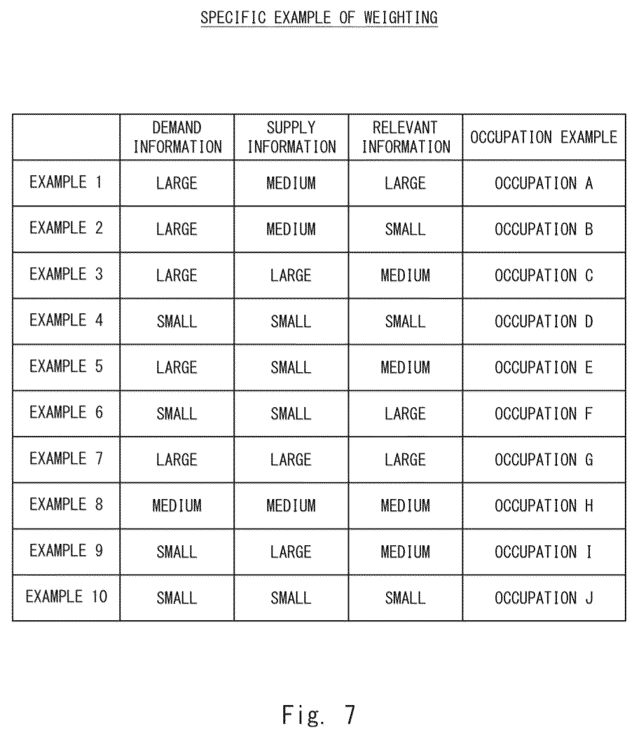

FIG. 7 is a diagram showing a specific example of weighting. In the diagram, the magnitudes of weights are shown at three levels: large, medium, and small. In the diagram, one of three levels is set for each of the demand information, the supply information, and the relevant information. The magnitude of the weight may be set in four or more levels, or in two levels. The magnitude of the weight may be set numerically.

For example, the weight setting unit 15 refers to a table (not shown) containing the information shown in the drawing to acquire the level of the weight according to the industry or profession. The weight setting part 15 sets weights for each of the demand information, the supply information, and the relevant information according to the acquired level.

For example, the value of the work performance ability possessed by an individual of occupation G as shown in Example 7 is relatively strongly related to the demand information, the supply information, and the relevant information. Therefore, the weight setting unit 15 sets a “large” weight for all of the demand information, the supply information, and the relevant information. The occupation G is, for example, an engineer who handles the latest technology.

On the other hand, the value of the work performance ability possessed by an individual of occupation D shown in Example 4 and an individual of occupation J shown in Example 10 is relatively weakly related to the demand information, the supply information, and the relevant information. Therefore, the weight setting unit 15 sets a “small” weight for all of the demand information, the supply information, and the relevant information.

In this way, the weight setting unit 15 can automatically perform weighting according to the industry or profession.

The weight setting unit 15 may receive input from a setter and set weights. The setter may be, for example, a corporate user using the corporate user terminal 30. Thus, the weight setting unit 15 can adjust the weight manually by the setter.

For example, the weight setting unit 15 first automatically performs weighting. Next, the weight setting unit 15 receives the input of the setter and changes the weight. The weight setting unit 15 re-trains the trained model 195 using the changed weight. In this way, the weight setting unit 15 can train the trained model 195 so that the value of the work performance ability can be estimated accurately. In this way, if there is a discrepancy between the estimation result using the automatically set weighting and the actual value, the setter can reduce this discrepancy by manually adjusting the weighting.

The setter can change the weighting of only a part of X1, X2, X3, . . . , and X8, for example, so that the weighting can be set flexibly. In this way, for example, if an event that can have a large impact on the supply or demand of the work performance ability occurs, the impact can be quickly reflected in the estimation result.

The order of weighting is not limited to those described above. The weight setting unit 15 may first perform weighting manually according to the input of the setter, and then perform weighting automatically. The weight setting unit 15 may set weighting automatically or manually a plurality of times.

The weight setting unit 15 may divide X1, X2, X3, . . . , and X8 into a plurality of groups and weight them in a group unit. For example, the weight setting unit 15 may divide six pieces of information included in the relevant information 193 into a plurality of groups and weight each group differently.

The storage unit 19 is a storage device which stores a program for implementing each function of the information processing apparatus 10. The storage unit 19 also stores the demand information 191, the supply information 192, the relevant information 193, the value information 194, and the trained model 195.

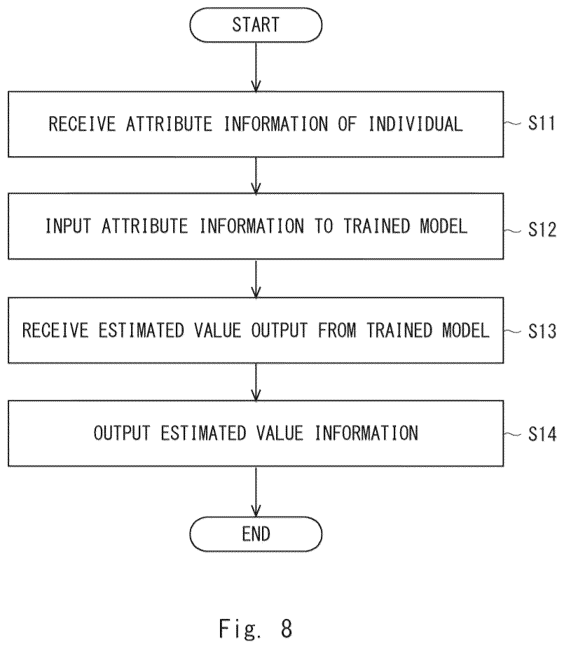

(Processing of Information Processing Apparatus 10) Next, with reference to FIG. 8, processing performed by the information processing apparatus 10 will be described. FIG. 8 is a flowchart showing the processing performed by the information processing apparatus 10.

First, the attribute information reception unit 11 receives the attribute information of the personal user (S11). For example, the attribute information reception unit 11 receives the information on the resume that the personal user has input to the personal user terminal 20 as the attribute information. The attribute information includes information on the work performance ability of the personal user. The work performance ability may include a plurality of skills, etc. The attribute information may also include information other than the work performance ability, such as the number of job changes and educational background.

Next, the value estimation unit 12 inputs the attribute information into the trained model 195. The value estimation unit 12 estimates the value of the work performance ability included in the attribute information using the trained model 195 based on the received attribute information of the personal user. The trained model 195 is previously trained in the training unit 14 using the demand information 191, the supply information 192, the relevant information 193, and the value information 194 as teacher data.

Specifically, the value estimation unit 12 inputs the attribute information to the trained model 195 (S12). The trained model 195 takes the attribute information as input and estimates the value of the work performance ability included in the attribute information. The value estimation unit 12 receives the estimated value from the trained model 195 (S13). Subsequently, the value output unit 13 outputs the estimated value information indicating the estimated value (S14). The value output unit 13 causes the output unit of the personal user terminal 20 to display the estimated value information, for example.

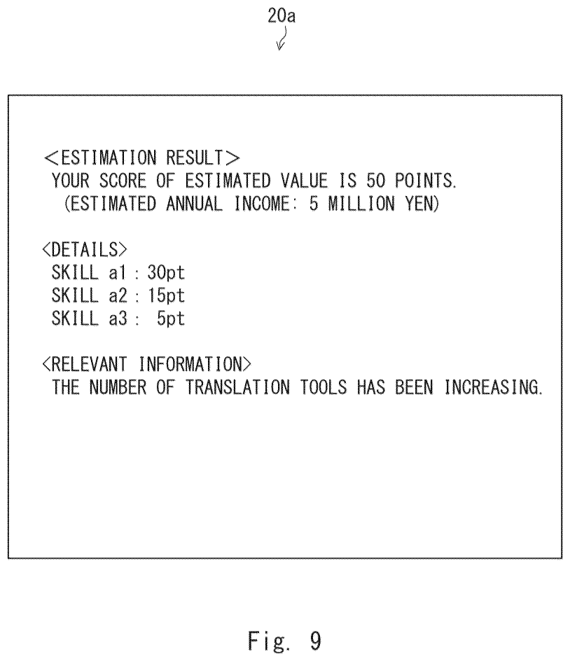

FIG. 9 is a diagram showing an example of display information for displaying the estimated value information. FIG. 9 shows display information 20a displayed on a display screen (output unit) of the personal user terminal 20 as an example.

As shown in the drawing, the display information 20a may include a score indicating the magnitude of the estimated value and annual income. The display information 20a may include, if the personal user has a plurality of skills as a work performance ability, a score or a consideration corresponding to each skill. The display information 20a may include relevant information or the like that has contributed to the estimation result. By displaying information that affects the value of the work performance ability, the personal user can specifically grasp the value of his/her work performance ability.

The value output unit 13 may also output the estimated value information to the corporate user terminal 30. For example, the value output unit 13 causes the output unit of the corporate user terminal 30 to display estimated value information indicating the work performance ability of a personal user who has applied for a job. The value output unit 13 may cause the output unit of the corporate user terminal 30 to display estimated value information indicating the work performance ability of a personal user who has viewed a job offer or who has expressed interest in a job offer.

Although not shown in the drawing, the training unit 14 may re-train the trained model 195 using the estimation result. For example, the weight setting unit 15 automatically changes the weight according to the estimation result. The weight setting unit 15 may manually change the weight by receiving the input from the setter. In this way, the accuracy of the estimation in the trained model 195 can be improved.

The configuration provided by the information processing system 1 and the processing performed by the information processing system 1 have been explained. The configuration of the information processing system 1 described above is only an example and can be changed as appropriate. For example, in a case where some or all of the components of the information processing apparatus 10 are implemented by a plurality of information processing apparatuses, circuits, etc., the plurality of information processing apparatuses, circuits, etc., may be disposed in one place in a centralized manner or disposed in a distributed manner.

For example, the information processing apparatuses, circuits, etc. may be implemented in a form of a client-server system, a cloud computing system, etc., each of which is connected through a communication network. The functions of the information processing apparatus 10 may be provided in the form of Software as a Service (SaaS).

For example, while FIG. 4 illustrates the example in which the information processing apparatus 10 includes the training unit 14 and the weight setting unit 15 and stores the generated trained model 195, this is merely an example.

Devices other than the information processing apparatus 10 may include the functions of the training unit 14 and the weight setting unit 15, or the trained model 195 may be stored in a device other than the information processing apparatus 10.

As described above, in the information processing system 1 according to the present disclosure, the information processing apparatus 10 estimates the work performance ability of the personal user using the trained model and outputs the estimation result. The trained model estimates the value of the work performance ability using, besides demand information and supply information, relevant information that can affect at least one of supply and demand. In this way, the information processing apparatus 10 can obtain the estimated value by taking into account the effects of alternative tools, world affairs, and the like. In this way, the information processing system 1 can appropriately evaluate the work performance ability of a personal user in accordance with changes in the current trends.

The information processing system 1 can visualize the value of the current work performance ability of the personal user by causing the estimated value to be displayed on the terminal of the personal user. Thus, the personal user can appropriately recognize the value of his/her work performance ability. In addition, the personal user can increase his/her motivation to improve his/her work performance ability.

The information processing system 1 may be used in various scenes to estimate the value of the work performance ability of the personal user. For example, the information processing system 1 may be used in a case where the project leader of the Decentralized Autonomous Organization (DAO) distributes revenue considering the market value of each member. The information processing system 1 can estimate the value corresponding to the work performance ability of each member (for example, knowledge experts, project managers, business designers, analysts, engineers, or researchers).

(Configuration example of hardware) Each functional component of the information processing apparatus 10 may be implemented by hardware (e.g., a hard-wired electronic circuit, etc.) for implementing each functional component, or by a combination of hardware with software (e.g., a combination of an electronic circuit with a program for controlling the same, etc.). Hereinafter, a case in which each functional component of the information processing apparatus 10 is implemented by a combination of hardware with software will be described.

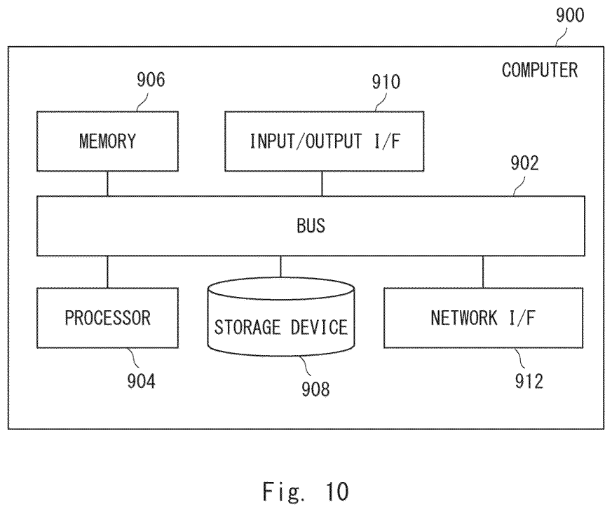

FIG. 10 is a block diagram illustrating a hardware configuration of a computer 900 implementing the information processing apparatus 10. The computer 900 may be a dedicated computer designed to implement the information processing apparatus 10 or a general-purpose computer. The computer 900 may be a portable computer such as a smartphone or a tablet terminal.

For example, by installing a predetermined application on the computer 900, each function of the information processing apparatus 10 is implemented on the computer 900. The application is composed of a program for implementing a functional component of the information processing apparatus 10.

The computer 900 includes a bus 902, a processor 904, a memory 906, a storage device 908, an input/output interface 910, and a network interface 912. The bus 902 is a data transmission path through which the processor 904, the memory 906, the storage device 908, the input/output interface 910, and the network interface 912 transmit and receive data to each other. However, the method of connecting the processor 904 and the like to each other is not limited to bus connection.

The processor 904 may be a variety of processors such as a Central Processing Unit (CPU), a Graphics Processing Unit (GPU), a Field-Programmable Gate Array (FPGA), or a quantum processor (Quantum Computer Control Chip).

The memory 906 is a main storage device implemented using a random access memory (RAM) or the like. The storage device 908 is an auxiliary storage device implemented using a hard disk, a solid state drive (SSD), a memory card, or a read only memory (ROM).

The input/output interface 910 is an interface for connecting the computer 900 and the input/output device. For example, an input device such as a keyboard and an output device such as a display device are connected to the input/output interface 910.

The network interface 912 is an interface for connecting the computer 900 to the network. The network may be a local area network (LAN) or a wide area network (WAN).

The storage device 908 stores a program for implementing each functional component of the information processing apparatus 10 (a program for implementing the aforementioned application). The processor 904 loads the program into the memory 906 and executes the loaded program, thereby implementing each functional component of the information processing apparatus 10.

Each of the processors executes one or more programs including a group of instructions for causing the computer to perform the algorithm described using the drawings. The program includes a group of instructions (or software code) for causing the computer to perform one or more functions described in the example embodiments when read into the computer. The program may be stored in various types of non-transitory computer readable medium or tangible storage medium. By way of example, but not limitation, a non-transitory computer readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disc or other optical disc storage, magnetic cassette, magnetic tape, magnetic disc storage or other magnetic storage device. The program may also be transmitted on various types of transitory computer readable medium or communication medium. By way of example, but not limitation, a transitory computer readable medium or communication medium may include an electrical, optical, acoustical, or other forms of propagated signals.

While the present disclosure has been described above with reference to the example embodiments, the present disclosure is not limited to the above-described example embodiments. Various changes that can be understood by those skilled in the art within the scope of the present disclosure can be made to the configurations and the details of the present disclosure. Each example embodiment can be combined as desirable with another example embodiment as appropriate.

Each of the drawings is merely an example for describing one or more example embodiments. Each of the drawings is not associated with only one particular example embodiment and may instead be associated with one or more other example embodiments. Those skilled in the art will appreciate that various features or steps described with reference to any one of the drawings may be combined with features or steps shown in one or more other drawings in order to produce, for example, example embodiments that are not explicitly illustrated or described. Not all the features or steps shown in any one of the figures to describe illustrative example embodiments are necessary, and some of the features or steps may be omitted. The order of the steps shown in any one of the figures may be changed as appropriate.

The whole or part of the example embodiments disclosed above can be described as, but not limited to, the following supplementary notes.

### Supplementary Note 1

An information processing apparatus comprising:
an attribute information reception unit configured to receive attribute information of an individual;
a value estimation unit configured to estimate, based on the attribute information of the individual received by the attribute information reception unit, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and
a value output unit configured to output estimated value information indicating the value estimated by the value estimation unit.

### Supplementary Note 2

The information processing apparatus according to Supplementary Note 1, further comprising:
a weight setting unit configured to set a weight for at least one of the demand information, the supply information, and the relevant information,
wherein the trained model performs training using the weight set in the weight setting unit.

### Supplementary Note 3

The information processing apparatus according to Supplementary Note 2, wherein the weight setting unit receives input from a setter and sets the weight.

### Supplementary Note 4

The information processing apparatus according to Supplementary Note 1 or 2, wherein the trained model acquires information extracted using natural language processing as the relevant information and performs training using the acquired relevant information.

### Supplementary Note 5

The information processing apparatus according to any one of Supplementary Notes 1 to 4, wherein the trained model performs training using a future market value estimated based on the demand information, the supply information, and the relevant information at a plurality of different times.

### Supplementary Note 6

The information processing apparatus according to any one of Supplementary Notes 1 to 5, wherein
the relevant information includes information on alternative means of the work performance ability, and
the trained model performs training so that the value becomes smaller as at least one of a quality and a quantity of the alternative means increases.

### Supplementary Note 7

The information processing apparatus according to any one of Supplementary Notes 1 to 6, wherein
the trained model acquires the demand information based on a plurality of job postings and acquires the supply information based on attribute information of a plurality of individuals, and
the trained model performs training by using the demand information and the supply information that have been acquired as the teacher data.

### Supplementary Note 8

The information processing apparatus according to any one of Supplementary Notes 1 to 7, wherein the relevant information includes information on trends in an industry to which a job offeror belongs.

### Supplementary Note 9

The information processing apparatus according to Supplementary Note 8, wherein the relevant information includes information extracted from a publication issued by the job offeror or the industry.

### Supplementary Note 10

A trained model comprising:
an input layer configured to receive input of demand information on a demand for the work performance ability, supply information on a supply of the work performance ability, and relevant information that may affect at least one of the demand and the supply; and
an output layer configured to estimate a value of the work performance ability corresponding to the demand information, the supply information, and the relevant information and output the estimated value,
wherein the trained model causes a computer to function to input a work performance ability included in attribute information of an individual into the input layer and output an estimated value from the output layer.

### Supplementary Note 11

The trained model according to Supplementary Note 10, wherein the trained model performs training using a weight set for at least one of the demand information, the supply information, and the relevant information.

### Supplementary Note 12

An information processing method comprising:
an attribute information reception step of receiving attribute information of an individual;
a value estimation step of estimating, based on the attribute information of the individual received in the attribute information reception step, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and
a value output step of outputting estimated value information indicating the value estimated in the value estimation step.

### Supplementary Note 13

The information processing method according to Supplementary Note 12, further comprising:
a weight setting step of setting a weight for at least one of the demand information, the supply information, and the relevant information,
wherein the trained model performs training by using the weight set in the weight setting step.

### Supplementary Note 14

The information processing method according to Supplementary Note 13, wherein, in the weight setting step, input is received from a setter and the weight is set.

### Supplementary Note 15

The information processing method according to Supplementary Note 12 or 13, wherein the trained model acquires information extracted using natural language processing as the relevant information and performs training using the acquired relevant information.

### Supplementary Note 16

The information processing method according to any one of Supplementary Notes 12 to 15, wherein the trained model performs training using a future market value estimated based on the demand information, the supply information, and the relevant information at a plurality of different times.

### Supplementary Note 17

The information processing method according to any one of Supplementary Notes 12 to 16, wherein
the relevant information includes information on alternative means of the work performance ability, and
the trained model performs training so that the value becomes smaller as at least one of a quality and a quantity of the alternative means increases.

### Supplementary Note 18

The information processing method according to any one of Supplementary Notes 12 to 17, wherein
the trained model acquires the demand information based on a plurality of job postings and acquires the supply information based on attribute information of a plurality of individuals, and
the trained model performs training by using the demand information and the supply information that have been acquired as the teacher data.

### Supplementary Note 19

A program for causing a computer to execute:
an attribute information reception step of receiving attribute information of an individual;
a value estimation step of estimating, based on the attribute information of the individual received in the attribute information reception step, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and
a value output step of outputting estimated value information indicating the value estimated in the value estimation step.

### Supplementary Note 20

The program according to Supplementary Note 19, causing the computer to further execute a weight setting step of setting a weight for at least one of the demand information, the supply information, and the relevant information,
wherein the trained model performs training by using the weight set in the weight setting step.

Note that some or all of the elements (e.g., the configurations and the functions) according to Supplementary Notes 2 to 9 that depend from Supplementary Note 1 may depend from Supplementary Notes 10, 12, and 19 as well according to a dependency relationship similar to that in Supplementary Notes 2 to 9. Some or all of the elements according to any Supplementary Note may be applied to various kinds of hardware, software, recording means for recording software, system, and method.

This application is based upon and claims the benefit of priority from Japanese patent application No. 2022-205626, filed on Dec. 22, 2022, the disclosure of which is incorporated herein in its entirety by reference.

### REFERENCE SIGNS LIST

1 INFORMATION PROCESSING SYSTEM
10 INFORMATION PROCESSING APPARATUS
11 ATTRIBUTE INFORMATION RECEPTION UNIT
12 VALUE ESTIMATION UNIT
13 VALUE OUTPUT UNIT
14 TRAINING UNIT
15 WEIGHT SETTING UNIT
19 STORAGE UNIT
20 PERSONAL USER TERMINAL
20a DISPLAY INFORMATION
30 CORPORATE USER TERMINAL
100 INFORMATION PROCESSING APPARATUS
101 ATTRIBUTE INFORMATION RECEPTION UNIT
102 VALUE ESTIMATION UNIT
103 VALUE OUTPUT UNIT
191 DEMAND INFORMATION
192 SUPPLY INFORMATION
193 RELEVANT INFORMATION
194 VALUE INFORMATION
195 TRAINED MODEL
900 COMPUTER
902 BUS
904 PROCESSOR
906 MEMORY
908 STORAGE DEVICE
910 INPUT/OUTPUT INTERFACE
912 NETWORK INTERFACE
L1 INPUT LAYER
L2 INTERMEDIATE LAYER
L3 OUTPUT LAYER
N NETWORK

What is claimed is:

1. An information processing apparatus comprising:
at least one memory storing instructions; and
at least one processor configured to execute the instructions to:
receive attribute information of an individual;
estimate, based on the received attribute information of the individual, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and
output estimated value information indicating the estimated value.

2. The information processing apparatus according to claim 1, wherein the at least one processor is further configured to execute the instructions to:
set a weight for at least one of the demand information, the supply information, and the relevant information,
wherein the trained model performs training using the set weight.

3. The information processing apparatus according to claim 2, wherein the at least one processor is further configured to execute the instructions to receive input from a setter and set the weight.

4. The information processing apparatus according to claim 1, wherein the trained model acquires information extracted using natural language processing as the relevant information and performs training using the acquired relevant information.

5. The information processing apparatus according to claim 1, wherein the trained model performs training using a future market value estimated based on the demand information, the supply information, and the relevant information at a plurality of different times.

6. The information processing apparatus according to claim 1, wherein
the relevant information includes information on alternative means of the work performance ability, and
the trained model performs training so that the value becomes smaller as at least one of a quality and a quantity of the alternative means increases.

7. The information processing apparatus according to claim 1, wherein
the trained model acquires the demand information based on a plurality of job postings and acquires the supply information based on attribute information of a plurality of individuals, and
the trained model performs training by using the demand information and the supply information that have been acquired as the teacher data.

8. The information processing apparatus according to claim 1, wherein the relevant information includes information on trends in an industry to which a job offer or belongs.

9. The information processing apparatus according to claim 8, wherein the relevant information includes information extracted from a publication issued by the job offeror or the industry.

10.-11. (canceled)

12. An information processing method comprising:
receiving attribute information of an individual;
estimating, based on the received attribute information of the individual, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and
outputting estimated value information indicating the estimated value.

13. The information processing method according to claim 12, comprising:
setting a weight for at least one of the demand information, the supply information, and the relevant information,
wherein the trained model performs training using the set weight.

14. The information processing method according to claim 13, wherein, in the setting of the weight, input is received from a setter and the weight is set.

15. The information processing method according to claim 12, wherein the trained model acquires information extracted using natural language processing as the relevant information and performs training using the acquired relevant information.

16. The information processing method according to claim 12, wherein the trained model performs training using a future market value estimated based on the demand information, the supply information, and the relevant information at a plurality of different times.

17. The information processing method according to claim 12, wherein
the relevant information includes information on alternative means of the work performance ability, and
the trained model performs training so that the value becomes smaller as at least one of a quality and a quantity of the alternative means increases.

18. The information processing method according to claim 12, wherein
the trained model acquires the demand information based on a plurality of job postings and acquires the supply information based on attribute information of a plurality of individuals, and
the trained model performs training by using the demand information and the supply information that have been acquired as the teacher data.

19. A non-transitory computer-readable medium storing a program for causing a computer to:
receive attribute information of an individual,
estimate, based on the received attribute information of the individual, a value of a work performance ability included in the attribute information by using a trained model trained by using demand information on a demand for the work performance ability, supply information on a supply of the work performance ability, relevant information that may affect at least one of the demand and the supply, and value information indicating a value of the work performance ability as teacher data; and
output estimated value information indicating the estimated value.

20. The non-transitory computer-readable medium according to claim 19, causing the computer to further set a weight for at least one of the demand information, the supply information, and the relevant information,
wherein the trained model performs training using the set weight.
